(19) United States
(12) Patent Application Publication
(10) Pub. No.: US 2023/0367852 A1
(43) Pub. Date: Nov. 16, 2023

(54) AUTHENTICATION-CONTROL SYSTEM, AUTHENTICATION-CONTROL APPARATUS, AUTHENTICATION-CONTROL METHOD AND PROGRAM

(71) Applicant: NIPPON TELEGRAPH AND TELEPHONE CORPORATION, Tokyo (JP)

(72) Inventors: Tetsuya OKUDA, Tokyo (JP); Yuichiro DAN, Tokyo (JP); Ryohei SUZUKI, Tokyo (JP); Koji CHIDA, Tokyo (JP)

(21) Appl. No.: 18/248,078

(22) PCT Filed: Nov. 2, 2020
(86) PCT No.: PCT/JP2020/041059

§ 371 Date: Apr. 6, 2023

(51) Int. Cl. G06F 21/10

(52) U.S. Cl. CPC G06F 21/1015

(57) ABSTRACT

An authentication-control system including one or more computers, the authentication-control system includes: a registration unit that, in response to a notification of registration of a software resource after a change, registers in a storage unit a person who has made the change as a right holder of the software resource after the change, together with a right holder of the software resource before the change; an inquiry control unit that, in response to a permission request for use or editing of the software resource, controls an inquiry as to permission or rejection to right holders registered in the storage unit regarding the software resource; and a response unit that makes a response indicating permission for the permission request when permission is obtained from all the right holders. As result, it is possible to appropriately control authorization for access to a software resource changed in a distribution process.

### TECHNICAL FIELD

The present invention relates to an authentication-control system, an authentication-control apparatus, an authentication-control method and a program.

### BACKGROUND ART

OAuth is known as an authorization mechanism for controlling use of software resources such as video contents, audio contents, programs, or data. However, in the OAuth, authorization control cannot be performed on a software resource shared by a plurality of right holders (that is, there are a plurality of owners). Therefore, a mechanism for aggregating and controlling authorizations among right holders has been proposed (for example, Patent Document 1) .

### RELATED-ART DOCUMENTS

### Patent Document

Patent Document 1: WO2020/145163

### SUMMARY OF INVENTION

### Problem to be Solved by the Invention

On the other hand, there is a case where, with respect to a software resource that is allowed to be varied or modified (hereinafter, referred to as “changed”) in the distribution process, it is desirable that a person who has made the change is added as a right holder of the software resource after the change.

However, in conventional technologies, it is difficult to add a new right holder in such a case.

The present invention has been made in view of the above points, and an object thereof is to appropriately control authorization for access to a software resource changed in a distribution process.

In order to solve the above problem, an authentication-control system including one or more computers includes: a registration unit that, in response to a notification of registration of a software resource after a change, registers in a storage unit a person who has made the change as a right holder of the software resource after the change, together with a right holder of the software resource before the change; an inquiry control unit that, in response to a permission request for use or editing of the software resource, controls an inquiry as to permission or rejection to right holders registered in the storage unit regarding the software resource; and a response unit that makes a response indicating permission for the permission request when permission is obtained from all the right holders.

### EFFECT OF INVENTION

Authorization for access to a software resource changed in a distribution process can be appropriately controlled.

### BRIEF DESCRIPTION OF DRAWINGS

FIG. 1 is a diagram illustrating an overall configuration example in an embodiment of the present invention.

FIG. 2 is a diagram illustrating a hardware configuration example of an authorization control server 10 in the embodiment of the present invention.

FIG. 3 is a diagram illustrating a functional configuration example of the authorization control server 10 in the embodiment of the present invention.

FIG. 4 is a diagram for explaining a first example of a processing procedure performed in the present embodiment.

FIG. 5 is a diagram illustrating a configuration example of a resource owner management DB 16.

FIG. 6 is a diagram for explaining a second example of a processing procedure performed in the present embodiment.

### MODE FOR CARRYING OUT THE INVENTION

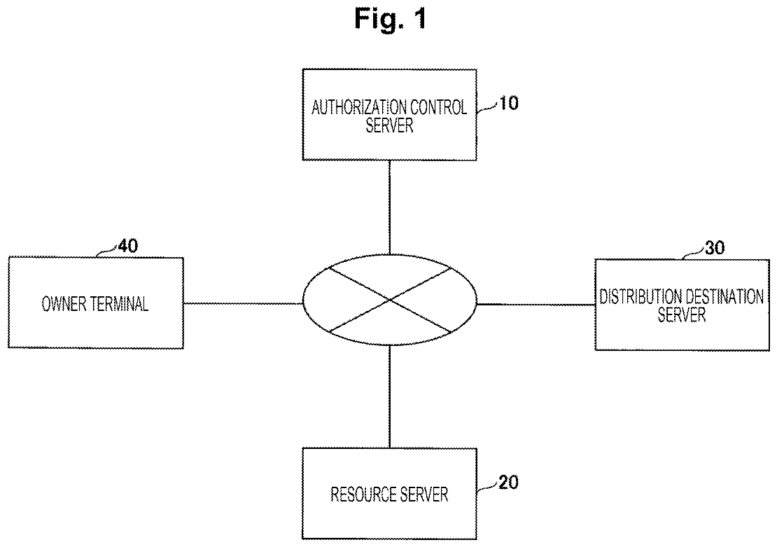

Hereinafter, an embodiment of the present invention will be described with reference to the drawings. FIG. 1 is a diagram illustrating an overall configuration example in an embodiment of the present invention. FIG. 1 illustrates one or more owner terminals 40, one or more distribution destination servers 30, one or more resource servers 20, and an authorization control server 10. For convenience, FIG. 1 illustrates that each server and each terminal are connected via a network, but the owner terminal 40 is only required to be able to communicate with the authorization control server 10.

The resource server 20 is one or more computers that store a software resource (hereinafter, simply referred to as a “resource”) such as a program or electronic data as a target to be managed. The types of programs and electronic data are not limited to predetermined ones. For example, an artificial intelligence (AI) program may be an example of the resource. Learning data of an AI program may be an example of the resource. In the present embodiment, a resource that is allowed to be varied or modified (hereinafter, referred to as “changed”) in the distribution process is preferable.

The owner terminal 40 is a terminal used by an owner of any resource stored in the resource server 20. For example, a personal computer (PC), a tablet terminal, a smartphone, or the like may be used as the owner terminal 40. The owner of a resource refers to a person (right holder) who has a right regarding use, change, or the like of the resource. Use or change of a certain resource requires permission of the owner of the resource. In the present embodiment, there may be a plurality of owners for one resource. For example, in a case where B creates a resource R1′ by changing a resource R1 created by A, A and B are owners of the resource R1′.

The distribution destination server 30 includes one or more computers or terminals to which resources are distributed. The resource distributed (downloaded) to the distribution destination server 30 is used or changed by a person (hereinafter, simply referred to as a “user”) who uses or changes the resource. Each user accesses the resource distributed to the distribution destination server 30 using each terminal.

The authorization control server 10 includes one or more computers that authorizes use of a resource distributed to the distribution destination server 30. Specifically, the authorization control server 10 inquires of each owner of the resource to be used or the like about permission or rejection for the use or the like of the resource. When the use of the like is permitted by each owner, the authorization control server 10 issues an access token for the resource to the distribution destination server 30.

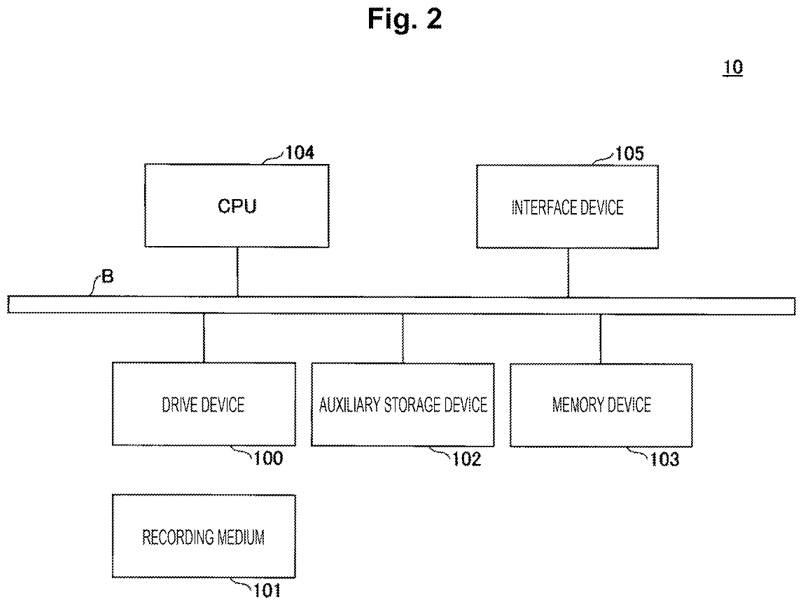

FIG. 2 is a diagram illustrating a hardware configuration example of the authorization control server 10 in the embodiment of the present invention. The authorization control server 10 in FIG. 2 includes a drive device 100, an auxiliary storage device 102, a memory device 103, a CPU 104, an interface device 105, and the like which are connected to each other by a bus B.

A program for implementing processing in the authorization control server 10 is provided by a recording medium 101 such as a compact disc read-only memory (CD-ROM) . When the recording medium 101 storing the program is set in the drive device 100, the program is installed from the recording medium 101 to the auxiliary storage device 102 via the drive device 100. However, the program is not necessarily installed from the recording medium 101, and may be downloaded from another computer via a network. The auxiliary storage device 102 stores the installed program and also stores necessary files, data, and the like.

In a case where an instruction to start the program is made, the memory device 103 reads and stores the program from the auxiliary storage device 102. The CPU 104 performs a function related to the authorization control server 10 according to a program stored in the memory device 103. The interface device 105 is used as an interface for connecting to a network.

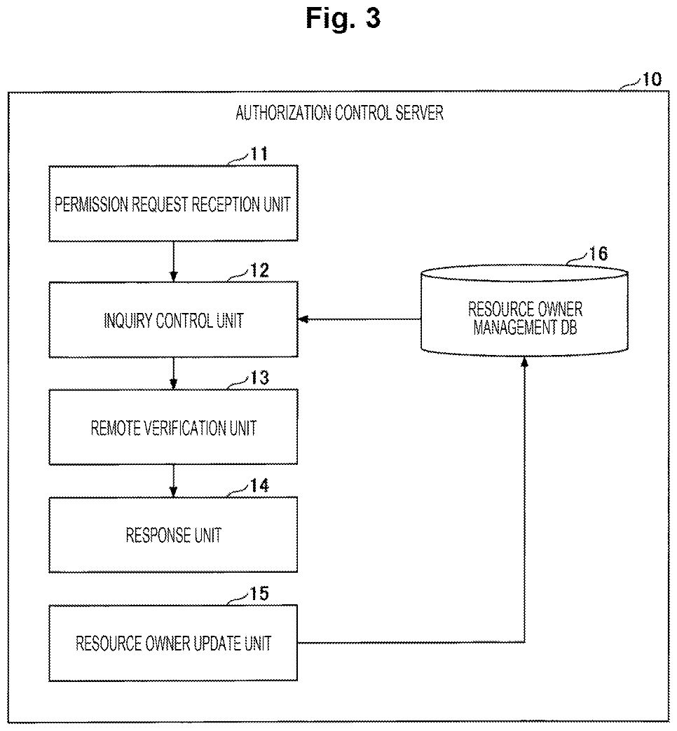

The distribution destination server 30, each resource server 20, and each owner terminal 40 may also have a hardware configuration as illustrated in FIG. 3.

FIG. 3 is a diagram illustrating a functional configuration example of the authorization control server 10 in the embodiment of the present invention. In FIG. 3, the authorization control server 10 includes a permission request reception unit 11, an inquiry control unit 12, a remote verification unit 13, a response unit 14, a resource owner update unit 15, and the like. Each of these units is implemented by processes that one or more programs installed in the authorization control server 10 cause the CPU 104 to execute. The authorization control server 10 also uses a database (storage unit) such as the resource owner management DB 16. The resource owner management DB 16 can be implemented by using, for example, the auxiliary storage device 102 or a storage device connectable to the authorization control server 10 via a network.

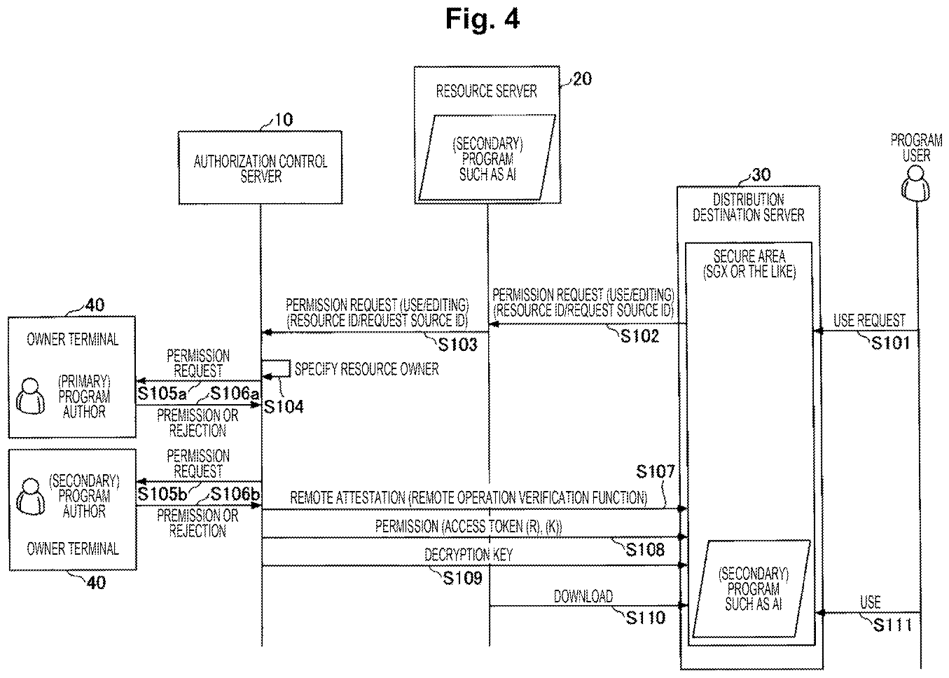

FIG. 4 is a diagram for explaining a first example of a processing procedure performed in the present embodiment. In FIG. 4, an example of a processing procedure performed in a case where a user (hereinafter, referred to as a “program user”) uses a (secondary) program such as AI stored in a certain resource server 20 will be described. The (secondary) program such as AI is a secondary program. That is, the (secondary) program such as AI is a program (hereinafter, referred to as a “target resource”) created by editing a program such as AI that has been created by a primary program author, by a secondary program author.

In step S101, a secure area of the distribution destination server 30 receives a use request of a target resource from a program user. The use request includes identification information (hereinafter, referred to as a “request source ID”) of the program user and identification information (hereinafter, referred to as a “resource ID”) of the target resource. The use request is transmitted from, for example, a terminal used by the program user. However, the distribution destination server 30 may be the terminal. The secure area is, for example, a type of trusted execution environment (TEE) such as Intel (registered trademark) Software Guard Extensions (SGX). It is assumed that the secure area satisfies conditions of “presence of an Enclave that cannot be tampered with”, “establishment of E2E secure channel of Enclave with a user (cloud administrator cannot perform the MitM attack) (cf. remote attestation)”, and “presence of a secure module in the Enclave from which a secret key is not released”.

Subsequently, the secure area of the distribution destination server 30 transmits a permission request for use or editing of the target resource to the resource server 20 storing the target resource (S102). The permission request includes a resource ID and a request source ID. Subsequently, the resource server 20 transfers the permission request to the authorization control server 10 (S103).

When the permission request is received by the permission request reception unit 11 of the authorization control server 10, the inquiry control unit 12 controls an inquiry about permission to each owner of the target resource with respect to the permission request. Specifically, the inquiry control unit 12 first refers to the resource owner management DB 16 to specify the owner of the resource ID included in the permission request (S104).

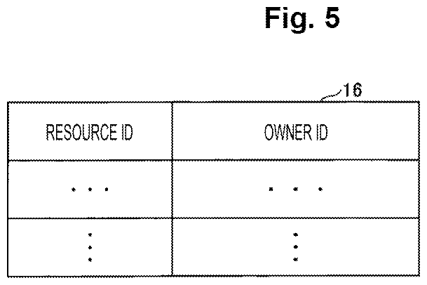

FIG. 5 is a diagram illustrating a configuration example of the resource owner management DB 16. As illustrated in FIG. 5, the resource owner management DB 16 stores an owner ID which is identification information of an owner of each resource stored in each resource server 20 in association with the resource ID of the resource. As described above, in the present embodiment, there may be a plurality of owners for one resource. Therefore, there is a possibility that a plurality of owner IDs are associated with one resource ID.

In step S104, the owner ID stored in the resource owner management DB 16 in association with the resource ID included in the permission request is specified. Here, not only the author of the (secondary) program such as AI which is the target resource but also the author of the (primary) program is specified as the owner of the target resource.

Subsequently, the inquiry control unit 12 of the authorization control server 10 transmits a permission request related to the use or editing of the target resource to the owner terminal 40 corresponding to each specified owner ID (S105a, S105b). Each owner terminal 40 notifies each user (owner) of the permission request (outputs the permission request to each user (owner)). Each owner inputs permission or rejection for the use or editing of the target resource, with reference to the permission request.

Subsequently, the inquiry control unit 12 receives a response including permission or rejection from each owner terminal 40 (S106a, S106b). The responses from the owner terminals 40 are received asynchronously.

When the response from any one of the owner terminals 40 of the transmission destination of the permission request indicates rejection, step S107 and subsequent steps are not performed. On the other hand, when the responses from all the owner terminals 40 of the transmission destination of the permission request indicate permission, the remote verification unit 13 of the authorization control server 10 verifies the validity of the secure area of the distribution destination server 30 (the validity of the transmission source of the permission request) by remote attestation (a remote operation verification function) (S107).

When the validity is confirmed, step S108 and subsequent steps are performed. In step S108, the response unit 14 transmits a response indicating permission to the distribution destination server 30. The response includes an access token (R) that is an access token for the target resource and an access token (K) that is an access token for a decryption key of the target resource.

In response to the reception of the response indicating permission, the secure area of the distribution destination server 30 acquires the decryption key by using the access token (K) from the authorization control server 10 also serving as the key management server (S109). That is, the secure area of the distribution destination server 30 transmits a decryption key acquisition request to the authorization control server 10. The acquisition request includes the access token (K). When the validity of the access token (K) is confirmed, the response unit 14 of the authorization control server 10 transmits the decryption key corresponding to the access token (K) to the secure area of the distribution destination server 30.

Subsequently, the secure area of the distribution destination server 30 downloads the target resource from the resource server 20 by using the access token (R) (S110). That is, the secure area of the distribution destination server 30 transmits an acquisition request of the target resource to the resource server 20. The acquisition request includes the access token (R). When the validity of the access token (R) is confirmed, the resource server 20 transmits the target resource corresponding to the access token (R) to the secure area of the distribution destination server 30. As a result, the target resource is stored in the secure area of the distribution destination server 30. At the time of confirming the validity of the access token (R), the resource server 20 requests the authorization control server 10 to verify the validity of the access token (R), and the authorization control server 10 performs the verification. The authorization control server 10 transmits a result of the verification to the resource server 20.

Thereafter, when a use instruction of the target resource is input from the program user (S111), the secure area of the distribution destination server 30 performs processing according to the use instruction. At this time, the target resource is decrypted with the decryption key.

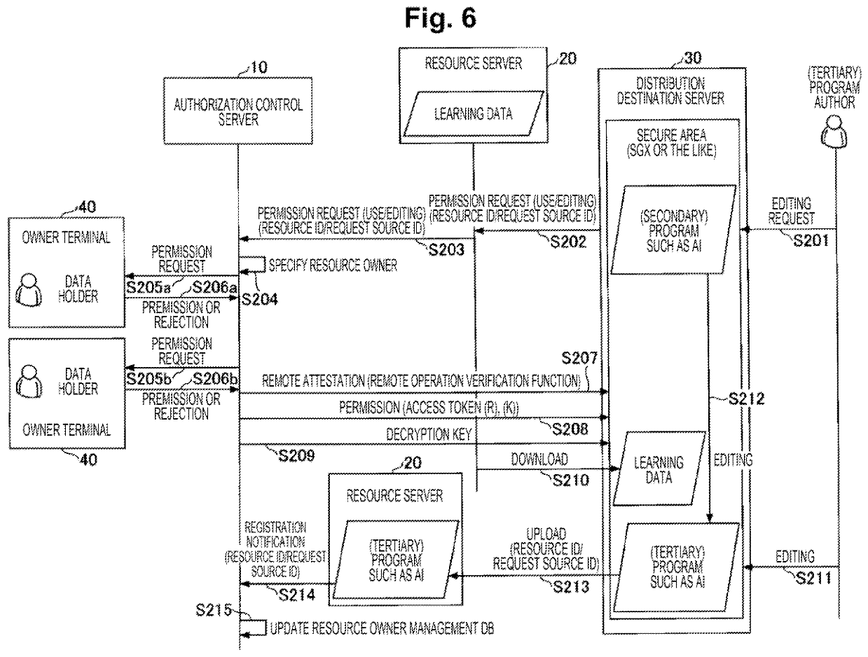

FIG. 6 is a diagram for explaining a second example of a processing procedure performed in the present embodiment. In FIG. 6, an example of a processing procedure performed in a case where a (tertiary) program such as AI is created by editing (additional learning or the like) the (secondary) program such as AI by using learning data (hereinafter, referred to as a “target resource”) stored in another resource server 20 will be described. The user who instructs such editing is hereinafter referred to as a “(tertiary) program author”.

In step S201, the secure area of the distribution destination server 30 receives an editing request of a (secondary) program such as AI from the (tertiary) program author. The editing request includes identification information (hereinafter, referred to as a “request source ID”) of the (tertiary) program author and identification information (hereinafter, referred to as a “resource ID”) of the target resource. Steps S102 to S110 of FIG. 4 are performed in response to the editing request or in response to an instruction by the (tertiary) program author before the editing request, and the (secondary) program such as AI is stored in the secure area of the distribution destination server 30.

Subsequently, the secure area of the distribution destination server 30 transmits a permission request for use or editing of the target resource to the resource server 20 storing the target resource (S202). The permission request includes a resource ID and a request source ID. Subsequently, the resource server 20 transfers the permission request to the authorization control server 10 (S203).

When the permission request is received by the permission request reception unit 11 of the authorization control server 10, the inquiry control unit 12 controls an inquiry about permission to each owner of the target resource with respect to the permission request. Specifically, the inquiry control unit 12 first refers to the resource owner management DB 16 (FIG. 5) to specify the owner of the resource ID included in the permission request (S204). Here, it is assumed that owner IDs of two data holders are specified as owners of the target resource.

Subsequently, the inquiry control unit 12 of the authorization control server 10 transmits a permission request related to the use or editing of the target resource to the owner terminal 40 corresponding to each specified owner ID (S205a, S205b). Each owner terminal 40 notifies each user (data holder) of the permission request (outputs the permission request to each user (data holder)). Each data holder inputs permission or rejection for the use or editing of the target resource, with reference to the permission request.

Subsequently, the inquiry control unit 12 receives a response including permission or rejection from each of the owner terminals 40 (S206a, S206b). The responses from the owner terminals 40 are received asynchronously.

When the response from any one of the owner terminals 40 of the transmission destination of the permission request indicates rejection, step S207 and subsequent steps are not performed. On the other hand, when the responses from all the owner terminals 40 of the transmission destination of the permission request indicate permission, the remote verification unit 13 of the authorization control server 10 verifies the validity of the secure area of the distribution destination server 30 (the validity of the transmission source of the permission request) (for example, verifies the PCR value) by remote attestation (a remote operation verification function) (S207).

When the validity is confirmed, step S208 and subsequent steps are performed. In step S208, the response unit 14 transmits a response indicating permission to the distribution destination server 30. The response includes an access token (R) that is an access token for the target resource and an access token (K) that is an access token for a decryption key of the target resource.

In response to the reception of the response indicating permission, the secure area of the distribution destination server 30 acquires the decryption key by using the access token (K) from the authorization control server 10 also serving as the key management server (S209). That is, the secure area of the distribution destination server 30 transmits a decryption key acquisition request to the authorization control server 10. The acquisition request includes the access token (K). When the validity of the access token (K) is confirmed, the response unit 14 of the authorization control server 10 transmits the decryption key corresponding to the access token (K) to the secure area of the distribution destination server 30.

Subsequently, the secure area of the distribution destination server 30 downloads the target resource from the resource server 20 by using the access token (R) (S210). That is, the secure area of the distribution destination server 30 transmits an acquisition request of the target resource to the resource server 20. The acquisition request includes the access token (R). When the validity of the access token (R) is confirmed, the resource server 20 transmits the target resource corresponding to the access token (R) to the secure area of the distribution destination server 30. As a result, the target resource is stored in an encrypted manner in the secure area of the distribution destination server 30.

Thereafter, when an execution instruction of editing (relearning using the target resource) of the (secondary) program such as AI is input from the (tertiary) program author (S211), the secure area of the distribution destination server 30 generates a (tertiary) program such as AI by performing processing according to the editing instruction (S212).

Subsequently, the secure area of the distribution destination server 30 uploads the (tertiary) program such as AI, the resource ID of the (secondary) program such as AI, and the request source ID of the (tertiary) program author to any one of the resource servers 20 (S213). The resource server 20 stores the (tertiary) program such as AI as a target to be managed. Before upload, the target resource is encrypted in the secure area, and the decryption key is managed by the authorization control server 10. The resource server 20 may be the same as or different from the resource server 20 that stores the (secondary) program such as AI.

Subsequently, the resource server 20 transmits a notification of registration of the (tertiary) program such as AI to the authorization control server 10 (S214). The registration notification includes a resource ID of the (secondary) program such as AI, a resource ID of the (tertiary) program such as AI, and a request source ID of the (tertiary) program such as AI author. Upon receiving the registration notification, the resource owner update unit 15 of the authorization control server 10 updates the resource owner management DB 16 (S215). Specifically, the resource owner update unit 15 specifies the owner ID stored in the resource owner management DB 16 in association with the resource ID of the (secondary) program such as AI included in the registration notification. The resource owner update unit 15 registers the resource ID of the (tertiary) program such as AI included in the registration notification in the resource owner management DB 16 in association with the specified owner ID and the request source ID of the (tertiary) program author included in the registration notification. That is, the owner group of the (secondary) program such as AI and the (tertiary) program author are registered in the resource owner management DB 16 as the owner of the (tertiary) program such as AI.

After the end of the use or editing of the target resource, the target resource and the decryption key are deleted from the secure area of the distribution destination server 30.

As described above, according to the present embodiment, when permission of all resource owners is obtained for a certain resource, access (use, editing, or the like) to the resource is permitted. For the resource after the change, in addition to the owner of the resource before the change, the person who has made the change is also added to the owner. Accordingly, it is possible to appropriately control authorization for access to a software resource changed in a distribution process. That is, authorization control corresponding to a case where the resource owner is added/changed asynchronously after the resource is distributed becomes possible.

In the distribution destination server 30, resources are accessed in the secure area. Accordingly, it is possible to perform remote authorization control on the client even after the resource is distributed or the resource is changed.

In the present embodiment, the authorization control server 10 is an example of an authentication-control system and an authentication-control apparatus. The resource owner update unit 15 is an example of a registration unit. The remote verification unit 13 is an example of a verification unit.

Although the embodiment of the present invention has been described in detail above, the present invention is not limited to such specific embodiment, and various modifications and changes can be made within the scope of the gist of the present invention described in the claims.

### REFERENCE SIGNS LIST

10 Authorization control server
11 Permission request reception unit
12 Inquiry control unit
13 Remote verification unit
14 Response unit
15 Resource owner update unit
16 Resource owner management DB
20 Resource server
30 Distribution destination server
40 Owner terminal
100 Drive device
101 Recording medium
102 Auxiliary storage device
103 Memory device
104 CPU
105 Interface device
B Bus

1. An authentication-control system comprising:
at least one computer including a memory and circuitry, the circuitry being configured to:
receive a notification of registration for a post-change software resource;
register, in response to receiving the notification in the memory
(i) a person who has made changes to a pre-change software resource, the person being registered as a first rights holder of the post-change software resource, and
(ii) a second rights holder of the pre-change software resource associated with the first rights holder;
receive a request to use or edit a software resource;
send, in response to receiving the request, an inquiry as to whether each of the first rights holder and the second rights holder registered in the memory in association with the requested software resource authorizes the use or edit of the software resource; and
transmit, to a corresponding computer, a response indicating that the request is granted, in a case where all rights holders associated with the requested software resource authorize the use of, or the editing of, the software resource.

2. The authentication-control system according to claim 1, wherein the circuitry is further configured to:
remotely verify that a device that transmits the request includes a secure area, and
transmit the response in a case where the secure area is successfully verified.

3. An authentication-control apparatus comprising:
a memory; and
circuitry configured to:
receive a notification of registration for a post-change software resource;
register, in response to receiving the notification in the memory,
(i) a person who has made changes to a pre-change software resource, the person being registered as a first rights holder of the post-change software resource, and
(ii) a second rights holder of the pre-change software resource associated with the first rights holder;
receive a request to use or edit a software resource;
send, in response to receiving the request, an inquiry as to whether each of the first rights holder and the second rights holder registered in the memory in association with the requested software resource authorizes the use or edit of the software resource; and
transmit, to an external device, a response indicating that the request is granted, in a case where all rights holders associated with the requested software resource authorize the use of, or the editing of, the software resource.

4. The authentication-control apparatus according to claim 3, wherein the circuitry is further configured to:
remotely verify that a device that transmits the request includes a secure area, and
transmit the response, in a case where the secure area is successfully verified.

5. An authentication-control method executed by a computer, the authentication-control method comprising:
receiving a notification of registration for a post-change software resource;
registering, in response to receiving the notification, in a memory.
(i) a person who has made changes to a pre-change software resource, the person being registered as a first rights holder of the post-change software resource, and
(ii) a second rights holder of the pre-change software resource associated with the first rights holder;
receiving a request to use or edit a software resource;
sending, in response to receiving the request, an inquiry as to whether each of the first rights holder and the second rights holder registered in the memory in association with the requested software resource authorizes the use or edit of the software resource; and
transmitting, to an external device, a response indicating that the request is granted, in a case where all rights holders associated with the requested software resource authorize the use of, or the editing of, the software resource.

6. The authentication-control method according to claim 5, further comprising:
remotely verifying that a device that transmits the request includes a secure area,
wherein the transmitting of the response is performed in a case where the secure area is successfully verified.

7. A non-transitory computer readable medium storing a program that causes a computer to execute the authentication-control method of claim 5.
